(19) United States
(12) Patent Application Publication
(10) Pub. No.: US 2014/0216478 A1
(43) Pub. Date: Aug. 7, 2014

(54) MULTILAYERED NONWOVEN FABRIC WITH ANTI-ALLERGIC EFFECT

(71) Applicants: Hae-Dong Park, Gyeonggi-do (KR); Junseok Lee, Gyeonggi-do (KR)

(72) Inventors: Hae-Dong Park, Gyeonggi-do (KR); Junseok Lee, Gyeonggi-do (KR)

(73) Assignee: 3M INNOVATIVE PROPERTIES COMPANY, St. Paul, MN (US)

(21) Appl. No.: 14/127,462

(22) PCT Filed: Jun. 19, 2012
(86) PCT No.: PCT/US2012/043162

§ 371 Date: Mar. 24, 2014

(30) Foreign Application Priority Data
Jun. 20, 2011 (KR) 10-2011-0059588

(51) Int. Cl. B32B 5/26; B32B 27/36; A41D 13/11; B32B 5/02

(52) U.S. Cl. CPC B32B 5/26; B32B 5/022; B32B 27/36; A41D 13/11
USPC 128/863; 442/382; 428/218; 156/60

(57) ABSTRACT

Provided are a multi-layered nonwoven fabric, comprising: an outer layer formed of a spunlaced nonwoven fabric including at least one of a bamboo fiber and a polyethyleneterephthalate (PET)-based fiber; a middle layer formed of a melt blown nonwoven fabric; and an inner layer formed of a melt blown nonwoven fabric or a melt blown-spunlaced nonwoven fabric, wherein the outer layer comprises an allergen inactivation agent; a method of manufacturing the same; and an anti-allergic product including the same. The multi-layered nonwoven fabric can exhibit good air permeability and weatherability, and even more, can inactivate an allergen and thus exhibit anti-allergic, anti-bacterial and anti-viral effects.

### BACKGROUND

Allergy is the response of the defense system of an organism against foreign substance (i.e., an antigen) that invades an organism. In other words, it's abnormal response of an immune system. Generally, when an antigen invades, an organism generates antibodies and lymphocytes with particular response. If this antigen invades again, the organism triggers various immune responses as a defense mechanism for self-preservation. This is known as an allergic response.

An allergen is an antigen that causes an allergic response. Exemplary allergens include dust mites, pollen, animal hair, skin fragment, vegetable fiber, germ, food, dye, chemical substance. The secretion of dust mites gets in by breathing or directly contacts skin which causes allergy. Pollen in the air gets in the eyes, nose and lungs of a human causing allergy. Specially, when pollen comes in the nose and the neck of a human, this causes a series of seasonal allergic rhinitis called pollen allergy.

Pet hair and skin fragments are also allergen. It can take more than 2 years for allergy to animal to be progressed. In some cases, the allergy can't be reduced more than 6 months after the contact is made with animal.

Multilayered non-woven fabric has been used as material for masks. But anti-allergic processed multilayered non-woven fabric that controls allergy has yet to be adequately developed.

### SUMMARY

This disclosure has a purpose of providing multilayered non-woven fabric and its manufacture method with excellent anti-allergic effect for various allergens and the effect of antibiosis and anti-virus that is economical and simple to manufacture.

This disclosure provides multilayered non-woven fabric and methods of manufacture that includes an outer layer with bamboo fiber, polyethyleneterephtalate (PET) type of fiber and spunlaced non-woven fabric including these; a middle layer with melt-blown non-woven fabric and an inner layer with melt-blown non-woven fabric or melt-blown spunlaced woven fabric. The outer layer includes allergen inactivation agent.

Anionic surfactant is particularly suitable for the allergen inactivation agent.

It's desirable, in some implementations, that the outer layer further includes antibiosis agent.

In certain implementation, it can be advantageous for the middle layer to be processed with corona static.

More than one of the fabric material of the middle and inner layers are typically selected from a group of consisting of polypropylene, polyolefin, polyester, and polyamide.

This disclosure provides anti-allergic product including previously mentioned multilayered non-woven fabric. Anti-allergic product can be selected from a group of mask, filter, gas mask, air purifier and air conditioner.

Multilayered non-woven fabric in this disclosure has excellent effects of anti-allergy and anti-virus. It can be used for anti-allergic products such as mask, filter, gas mask, air purifier and air conditioner.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further described with reference to the drawings, wherein corresponding reference characters indicate corresponding parts throughout the several views, and wherein:

FIG. 1 is a section view of multilayered non-woven fabric in one embodiment of the disclosure.

FIG. 2 shows the outer structure of a mask with multilayered non-woven fabric based on one embodiment of this disclosure.

FIG. 3 is a graph that shows the result of measuring inactivation function of various allergens (dust mite, pollen, and pets) with multilayered non-woven fabric in Example 1 and non-woven fabric in the Comparative Example 1.

### DETAILED DESCRIPTION OF ILLUSTRATIVE EMBODIMENTS

But, this invention isn't limited to those performing examples and Figures. It can be specified or changed in another form.

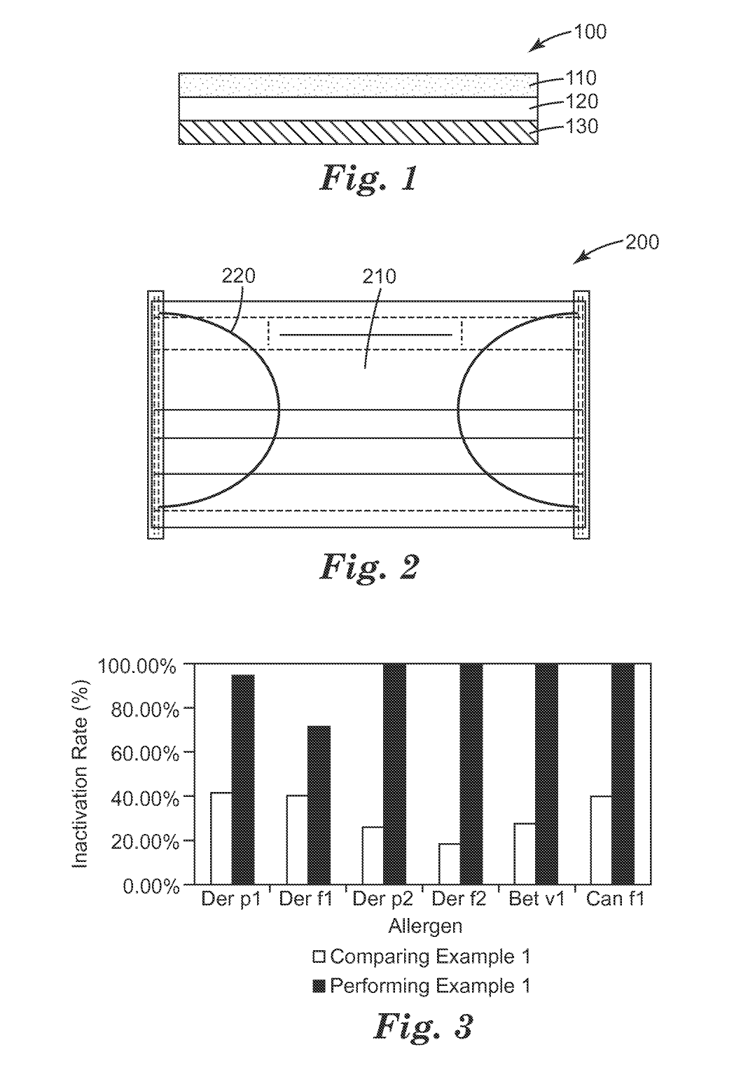

FIG. 1 is a cross-sectional view of multilayered non-woven fabric in one performing example in this invention. As shown in FIG. 1, multilayered non-woven fabric (100) in this invention includes 3 layered non-woven fabric layers that include a first outer layer (110), a middle layer (120) and a second outer layer (130). The first outer layer (110) includes an allergen inactivation agent.

The first outer layer (110) in the multilayered non-woven (100) fabric in this invention can be comprised of bamboo fabric, polyethyleneterephtalate (PET) fiber or spunlaced non-woven fabric.

Spunlaced non-woven fabric can be a fluid combined non-woven fabric. In certain implementations, the fluid combined non-woven is a 3-dimensional fiber assembly that is combined by friction movement between fibers by blasting fluid at high pressure without a chemical tool or thermal tool. Spunlaced non-woven fabric does not include an adhesion point by glue or a fusion point between fibers. Therefore, it looks like textile and is soft with enhanced drape property. It has excellent absorption and a property of supplementary solution. It is safe to use solvent and not harmful to humans. Typically, spunlaced non-woven fabrics include rayon. But this disclosure uses bamboo fiber, polyethyleneterephtalate (PET) type of fiber or fibers including a combination of bamboo and PET.

The bamboo fiber can be manufactured by radiating cellulose that is extracted from dissolving chipped bamboo. Bamboo fabric has high tear strength, crease resistance, absorption, air permeability and deodorization. Also, it has the properties of UV ray interruption, anion generation, static prevention, and durability. Also, bamboo fabric has excellent antibiosis, so it can be used for the outer layer in this invention with spunlaced non-woven fabric without separate antibiosis process.

Also, common PET type of fiber that is known to the industry can be used without limit for polyethyleneterephtalate (PET) type of fiber. For an example, it can use the fiber that has major ingredients of terephthalic acid and ethyleneglycol and adjusts this weight ratio and radiates.

The first outer layer of spunlaced non-woven fabric (110) can be made by mixing the above bamboo fiber and the PET type of fiber in an appropriate ratio. The mix ratio can be adjusted within the common range, as will be appreciated by those having skill in the art, considering the form maintenance and the antibiosis of outer layer. Also, the outer layer of the spunlaced non-woven fabric (110) can be 20-60 g/m² in basis weight with the consideration of the strength, process, flexibility, air permeability of non-woven fabric.

The first outer layer of spunlaced non-woven fabric (110) including the bamboo fabric and/or PET type of fiber in this invention contains allergen inactivation agent by anti-allergic process.

Anti-allergic process means the process of coating or dipping the outer layer of the invention (110) with allergen inactivation agent or the solution of allergen inactivation agent. The method of coating allergen inactivation agent can be gravure, spray, screen print, or other known processes.

The allergen inactivation agent is a substance that absorbs and changes the protein substance that causes allergy reducing allergen activation. It can be used without limit as long as it reduces or inactivates the target allergen, which is typically commonly known to the industry. The allergen that is the object of allergen inactivation agent can be an animal allergen or a vegetable allergen. For typical examples, it's the cause of allergy disease—a type of house dust mite, pollen and pets. The allergen inactivation agent in the invention should be ideally anionic surfactant with enhanced detergency and emulsifying characteristics. The amount of the allergen inactivation agent is not particularly limited. For example, the weight of the allergen inactivation agent of the outer layer (110) can be 2.0 g/m² or more.

During the anti-allergic process, allergen inactivation agent can be used by adding to solvent or binder or additives that can increase the anti-allergic effect, if necessary. Suitable solvents are those that can dissolve or distribute allergen inactivation agent. For example, suitable solvents include, but are not limited to, water, alcohol kind (methylalcohol, alcohol, propyl alcohol), a kind of hydrocarbon (toluene, xylene, methylnaphthalene, kerosene, cyclohexane), ether kind (dimethyleter, tetrahydrofuran, dioxane), ketone kind (acetone, methylethylketone), and amide kind (N,N-dimethylformamide).

Also, non-limiting examples of additives that can increase the anti-allergic effect can be an organic acid such as citric acid, malic acid, tartaric acid, benzoic acid, lactic acid, gluconic acid, ascorbic acid, gallic acid, aluconic acid, maleic acid; chelation agent such as ethyleneaminetetraacetic acid (EDTA) tetrasodium; or combinations thereof. The allergen inactivation agent can be used with medicine aids such as humectants, antioxidants, UV ray absorbent or tick sanitizers, other sanitizers, fungus removers, deodorizers within the range that doesn't reduce the reducing effect and the effectiveness of allergen.

The outer layer (110) can be anti-bacterial processed. A separate antibiosis layer can be further included. The above method of antibiosis process can be a method that antibiosis substance is sprayed and dried or dipped. Also, the antibiosis substance can be inorganic or organic bactericides with heat resistance—for example, PHMB.

The middle layer (120) fused with the one side of the previously mentioned spunlaced non-woven fabric (110) in the invention can be comprised of melt-blown non-woven fabric.

Melt-blown non-woven fabric includes 3 dimensional fiber assemblies with the web-like structure that diameter 10 μm or less of fine fibers are combined with each other. The melt-blown non-woven fabric is non-woven fabric that has high filtering function with microfiber laminated on the screen. It gathers fine dust particle or dusts in the air. Also, the melt-blown non-woven fabric has excellent elasticity and air permeability as well as tensile characteristics. Therefore, it can be used as non-woven fabric, filtering agent, absorbent and insulator with high function for new members.

The fiber material for the middle layer (120) isn't specially limited. For example, a type of polypropylene, polyolefin, polyester, polyamide or other fiber mixed with these can be used.

As mentioned above, the middle layer (120) with melt-blown non-woven fabric has the function of filter or filtration media. In order to enhance this filter function, the middle layer can be additionally static processed with corona discharge, plasma charge, water charge using charged water bubble or a form mixed with these. The method of corona static process is ideal, in certain circumstances.

Also, the middle layer (120) is static processed non-woven fabric filter with 20-40 g/m² basis weight. The efficiency of dust gathering 80-99.9% range is desirable.

The inner layer (130) in the invention bound with the previously mentioned outer layer (110) and the middle layer (120) can be comprised of melt-blown non-woven fabric or melt-blown spunlaced non-woven fabric.

The fiber material of the inner layer (130) of this invention can be same as or different than the material of the middle layer (120). Exemplary fiber material can be a fiber type of polypropylene, polyolefin, polyester, polyamide or other fiber mixed with these.

Like the earlier mentioned outer layer, the non-woven fabric with 20-60 g/m² basis weight is typical for the inner layer (130).

The multilayered non-woven fabric in the disclosure can be manufactured with the following methods. However, those skilled in the art will appreciate other methods for manufacturing may be used.

One performing example of the manufacturing method can include (1) a step that bamboo fiber, polyethyleneterephtalate (PET) type of fiber, or spunlaced non-woven fabric including these; melt-blown non-woven fabric or melt-blown spunlaced non-woven fabric are laminated and fused in order manufacturing the multilayered non-woven fabric, (2) a step of coating the spunlaced non-woven fabric of manufactured multilayered non-woven fabric with allergen inactivation agent.

Also, another performing example of the manufacture method can include (1) a step of coating bamboo fiber, polyethyleneterephtalate (PET) type of fiber, or spunlaced non-woven fabric including these with allergen inactivation agent; melt-blown non-woven fabric or melt-blown spunlaced non-woven fabric are laminated and fused in order manufacturing the multilayered non-woven fabric, (2) a step that melt-blown non-woven fabric and melt-blown non-woven fabric or melt-blown spunlaced non-woven fabric are laminated and fused in order on one side of the coated spunlaced non-woven fabric.

This coating step can be processed with gravure or spray coating. Also, the 3 layered non-woven fabrics can be combined with various methods including adhesive, thermal or ultrasonic binding agent. Also it can be combined with common physical methods that are known to the industry.

As mentioned earlier, this invention is structured with spunlaced non-woven fabric including bamboo fiber or polyethyleneterephtalate (PET) type of fiber; non-woven laminate that melt-blown non-woven fabric; melt-blown non-woven fabric or melt-blown spunlaced non-woven fabric are laminated in order.

The strength of multilayered non-woven fabric is increased by the bamboo fiber or PET type of non-woven fabric placed on the outer layer with this type of laminating. Also, the function of melt-blown non-woven fabric or melt-blown spunlaced non-woven fabric with relatively small pore can last longer by placing non-woven fabrics with large pore on the outer layer and non-woven fabrics with small pore on the inner layer. Also, multilayered non-woven fabric can have excellent durability by not placing relatively weak non-woven fabric at the maximum outer angle.

The multilayer non-woven fabric can function as filter with high function by placing spunlaced non-woven fabric on the surface layer and melt-blown non-woven fabric on the middle layer in this invention. It can provide the effect of anti-allergy, anti-virus and antibiosis by preventing pathogen from penetrating inside with the allergen inactivation agent included on the maximum outer angle layer.

The inhalation resistance of facial part on the multilayered non-woven fabric with 3 layers for the rate of air penetrating in this invention should be ideally 10.3 mmH₂O or less. It can be used as a mask with this range.

The multilayered non-woven fabric with 3 layer lamination is an example in this disclosure. The number and the laminating location of non-woven fabric in the multilayered non-woven fabric depending on the usage can be freely selected within the range of disclosure.

The multilayered non-woven fabric in this disclosure can be used for various anti-allergic products.

The non-limited examples of this anti-allergic product can be mask, filter, air purifier, air conditioner and gas mask. For example, FIG. 2 shows the mask body (210) with multilayered non-woven fabric in this invention and a mask with ear rings (220). The outer layer with anti-allergic process should be ideally placed facing the layer that contacts a face on the mask body (210).

### EXAMPLES

This invention is detailed with performing examples below. This invention is not limited to the following examples of performing and experimenting.

### Performing Example 1

Spunlaced non-woven fabric was produced with textile made with bamboo fiber. Gravure coating was made to 40 g/m² weight of allergen inactivation agent with chemical disodum hexadecyldiphenyloxide disulfonate 20 weight % as effective ingredient, citric acid 2 weight %, polyhexamethylene biguanide 2 weight % and water 76 weight % on the spunlaced non-woven fabric. After it was dried, anti-allergic process was given. Melt-blown non-woven fabric and melt-blown spunlaced non-woven fabric were laminated in order on one side of this anti-allergic spunlaced non-woven fabric. Ultrasonic fusion was deployed and 3 layered non-woven fabrics were produced. The melt-blown non-woven fabric used as a middle layer was G100 rating of corona processed non-woven fabric.

A mask body was made with the produced multilayered non-woven fabric. Ear rings were placed on one side of the mask body. Ear rings were made with cotton yarn. They were fused and attached on one side of mask body (FIG. 2)

### Performing Example 2

Antibiosis process was made on the outer layer of the mask body from the performing example 1. PHMB was used for bactericides.

### Comparative Example 1

A mask body was produced with a single layered polyester non-woven fabric without anti-allergic process. Ear rings were installed on this and a mask was made.

### Test of Anti-Allergic Evaluation

The ELISA—enzyme LISA method was used to measure the inactivation function for allergen in this invention. This method checks the color change that is caused by antigen antibody response to measure allergen concentration.

The manufacture method and the method to measure the test result of the sample and the response reagent used in the performing example of this disclosure is as shown below. The test was given with a variety of specific effective ingredient, the type of allergen, the covering amount of effective ingredient in each performing and comparing example.

1. Making Response Reagent

Used allergen

House Dust Mite: Der p 1, Der f 1, Der p 2, Der f 2

Pollen: Bet v 1 (Birch tree)

Pets: Can f 1 (Pet dander)

The product of Inbio Corporation was used for the ELISA test kit for each antigen. Each antigen was dissolved in PBS. Test allergen solution 250 ng/ml was produced. The instruction of ELISA kit supplier was followed for other method of making reagent.

2. Response of Sample and Each Antigen

Each sample was cut by 5×5 mm. It was put in antigen solution (250 ng/ml) 300 μl and left for 1 hour at 25° C. One hour later, this solution (equivalent solution) 100 μl as antibody was put in covered 96 well microplate. The optical density of 405 nm was measured with microplate reader. Allergen concentration was measured in each sample.

3. Measuring Test Result

The concentration of each antigen was measured in the response solution with the sample using microplate reader in 405 nm to calculate allergen inactivation efficiency.

Efficiency (%) (i.e., allergen inactivation rate (%))=(250−measured concentration of each sample)/250

### Performing Example 1 and Comparative Example 1

The allergen of four types of house dust mite (Der p 1, Der f 1, Der p 2, Der f 2), pollen (Bet v 1) and pets (Can f 1) was used as each test allergen. The protein concentration of the allergen for pollen (Bet v 1) and pets (Can f 1) were 250 ng/ml. Each removing efficiency for the allergen inactivation agent with disodium hexadecyl diphenyl oxide disulfonate as an effective ingredient was measured after the covering amount of the total effective ingredient among the samples was made for 1 g/m². The result is shown below in the Table 1.

TABLE 1
Bacterial Reduction

| | Number of | | Rate of |
|---|---|---|---|
| | vaccinated | Number of | anti-bacteria |
| | bacteria | bacteria after | reduction |
| | (0 hour) | 24 hours | (%) |
| Mask in performing | 8.60 × 10⁴ | 0.6 × 10² | >99.8% |
| example 1 | | | |
| Comparative example 1 | 2.0 × 10⁵ | 1.1 × 10⁸ | 0% |
| (Non-woven mask | | | |
| without process) | | | |

When the allergen inactivation agent in this disclosure was used for Der p 1, Der f 1, Der p 2, Der f 2, Bet v 1, Can f 1, the efficiency of allergen inactivation was much better than non-processed sample, as can be appreciated by reference to Table 2 and FIG. 3.

TABLE 2
Allergen Inactivation Rate

| Allergen | Performing Example 1 | Comparative Example 1 |
|---|---|---|
| Der p 1 | 94.6% | 41.2% |
| Der f 1 | 70.5% | 38.9% |
| Der p 2 | 99.0% | 25.5% |
| Der f 2 | 99.0% | 18.4% |
| Bet v 1 | 99.9% | 27.2% |
| Can f 1 | 99.9% | 39.5% |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A multi-layered nonwoven fabric, comprising:
an outer layer formed of a spunlaced nonwoven fabric comprising at least one of a bamboo fiber and a polyethyleneterephthalate (PET)-based fiber; and
an inner layer formed of a melt blown nonwoven fabric or a melt blown-spunlaced nonwoven fabric,
wherein the outer layer comprises an allergen inactivation agent.

2. The multi-layered nonwoven fabric of claim 1, wherein the allergen inactivation agent is an anionic surfactant.

3. The multi-layered nonwoven fabric of claim 1, wherein the outer layer further comprises an anti-bacterial agent.

4. The multi-layered nonwoven fabric of claim 1, and further comprising a middle layer formed of a melt blown nonwoven fabric.

5. The multi-layered nonwoven fabric of claim 4, wherein the middle layer has been subjected to corona electrostatic treatment.

6. The multi-layered nonwoven fabric of claim 4, wherein each of the nonwoven fabrics of the middle layer and the inner layer comprises at least one fiber selected from the group consisting of a polypropylene-based fiber, a polyolefin-based fiber, a polyester-based fiber and a polyamide-based fiber.

7. The multi-layered nonwoven fabric of claim 4, wherein each of the nonwoven fabrics constituting the outer layer and the inner layer has a weight per unit area ranging from 20 to 60 g/m², and
wherein the nonwoven fabric constituting the middle layer has a weight per unit area ranging from 20 to 40 g/m² and a dust collection efficiency ranging from 80 to 99.9%.

8. An anti-allergic product comprising the multi-layered nonwoven fabric of claim 6.

9. The anti-allergic product of claim 8, which is selected from the group consisting of a mask, a filter, an anti-gas mask, an air cleaner and an air conditioner.

10. A method of manufacturing a multi-layered nonwoven fabric, the method comprising:
(i) sequentially stacking (a) a spunlaced nonwoven fabric comprising at least one of a bamboo fiber and a polyethyleneterephthalate (PET)-based fiber, (b) a melt blown nonwoven fabric, and (c) a melt blown nonwoven fabric or a melt blown-spunlaced nonwoven fabric to obtain a multi-layered nonwoven fabric; and
(ii) coating a surface of the spunlaced nonwoven fabric of the multi-layered nonwoven fabric with an allergen inactivation agent.

11. A method of manufacturing a multi-layered nonwoven fabric, the method comprising:
(i) coating a spunlaced nonwoven fabric comprising at least one of a bamboo fiber and a polyethyleneterephthalate (PET)-based fiber with an allergen inactivation agent; and
(ii) sequentially stacking (a) a melt blown nonwoven fabric and (b) a melt blown nonwoven fabric or a melt blown-spunlaced nonwoven fabric on a surface of the spunlaced nonwoven fabric, followed by lamination and bonding.

12. The method of claim 10, wherein the coating comprises gravure coating or spray coating.

13. The method of claim 11, wherein the coating comprises gravure coating or spray coating.
